(19) United States
(12) Patent Application Publication
(10) Pub. No.: US 2013/0265453 A1
(43) Pub. Date: Oct. 10, 2013

(54) Virtual Shutter Image Capture

(71) Applicants: Daniel C. Middleton, Independence, MN (US); Mark C. Pontarelli, Lake Oswego, OR (US)

(72) Inventors: Daniel C. Middleton, Independence, MN (US); Mark C. Pontarelli, Lake Oswego, OR (US)

(21) Appl. No.: 13/993,691

(22) PCT Filed: Dec. 28, 2011
(86) PCT No.: PCT/US11/67457

§ 371 Date: Jun. 13, 2013

(51) Int. Cl. H04N 5/76

(52) U.S. Cl. CPC H04N 5/76
USPC 348/207.1; 348/231.99

(57) ABSTRACT

In accordance with some embodiments, no shutter or button needs to be operated in order to select a frame or group of frames for image capture in “buttonless frame selection”, as used herein. This frees the user from having to operate the camera to select frames of interest. In addition, it reduces the amount of skill needed in order to time the operation of a button to capture exactly that frame or group of frames that are really of interest.

### BACKGROUND

This relates generally to image capturing including still and motion picture capture.

Generally, a shutter is used in a still imaging device such as a camera to select a particular image for capture and storage. Similarly in movie cameras, a record button is used to capture a series of frames to form a clip of interest.

Of course one problem with both of these techniques is that a certain degree of skill is required to time the capture to the exact sequence that is desired.

### BRIEF DESCRIPTION OF THE DRAWINGS

FIG. 1 is a schematic depiction of an image capture device in accordance with one embodiment;

FIG. 2 is a post-capture virtual shutter apparatus in accordance with one embodiment to the present invention'

FIG. 3 is a real time virtual shutter apparatus in accordance with one embodiment to the present invention;

FIG. 4 is a flow chart for one embodiment of the present invention for a post-capture virtual shutter embodiment;

FIG. 5 is a flow chart for a real time virtual shutter embodiment; and

FIG. 6 is a flow chart for another embodiment of the present invention.

### DETAILED DESCRIPTION

In accordance with some embodiments, no shutter or button needs to be operated in order to select a frame or group of frames for image capture in “buttonless frame selection”, as used herein. This frees the user from having to operate the camera to select frames of interest. In addition, it reduces the amount of skill needed in order to time the operation of a button to capture exactly that frame or group of frames that are really of interest.

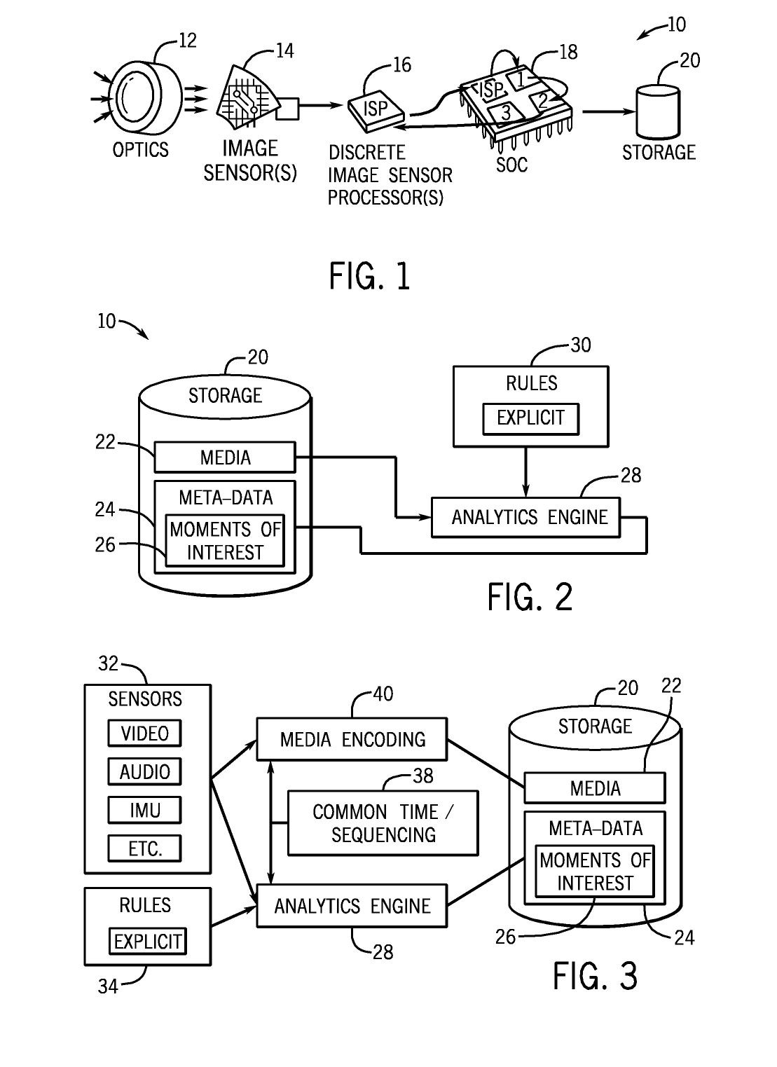

Thus, referring to FIG. 1, an imaging device 10, in accordance with one embodiment, may include optics 12 that receive light from a scene to be captured on image sensors 14. The image sensors may then be coupled to discrete image sensor processors (ISPs) 16 that in one embodiment may be integrated in one system on a chip (SOC) 18. The SOC 18 may be coupled to a storage 20.

Thus in some embodiments, a frame or group of frames is selected without the user ever having ever having operated a button to indicate which frame or frames the user wants to record. In some embodiments, post-capture analysis may be done to find those frames that are of interest. This may be done using audio or video analytics to find features or sounds within the captured media that indicate that the user wishes to record a frame or group of frames. In other embodiments, specific image features may be found in order to identify the frame or frames of interest in real time during image capture.

Referring to FIG. 2, a post-capture virtual shutter embodiment uses a storage device 20 that contains stored media 22. The stored media may include a stream of temporally successive frames recorded over a period of time. Associated with those frames may be metadata 24 including moments of interest 26. Thus metadata may point to or indicate information about what is really of interest within the sequence of frames. Those sequences of frames may include one or more frames that correlate to the moments of interest 26 that are the frames that the user really wants.

In order to identify those frames, rules may be stored as indicated at 30. These rules indicate how to determine what it is that the user wants to get from the captured frames. For example, after the fact, a user may indicate that really what he or she was interested in recording was the depiction of friends at the end of a trip. The analytics engine 28 may analyze the completed audio or video recorded content in order to find that specific frame or frames of interest.

Thus, in some embodiments a continuous sequence of frames are recorded and then after the fact, the frames may be analyzed, using video or audio analytics, together with user input to find the frame or frames of interest. It is also possible after the fact to find particular gestures or sounds within the continuously captured frames. For example, proximate in time to the frame or frames of interest, the user may make a known sound or gesture which can be searched for thereafter in order to find the frame or frames of interest.

In accordance with another embodiment shown in FIG. 3, the sequence of interest may be identified in real time as the image is being captured. Sensors 32 may be used for recording audio, video and still pictures. Rules engine 34 may be provided to indicate what it is that the system should be watching for in order to indicate one or more frames or a time of interest. For example, in the course of capturing of frames, user may perform a gesture or make a sound that is known by the recording apparatus to be indicative of a moment of interest. When the moment of interest is signaled in that way, frames temporally proximate to the time frame of the moment of interest may be flagged and recorded.

The sensors 32 may be coupled to media encoding device 40 which is coupled to the storage 20 and provides the media 22 for storage in the storage 20. Also coupled to the sensors is the analytics engine 28 itself coupled to the rules engine 34. The analytics engine may be coupled to the metadata 24 and the moments of interest 26. The analytics engine may be used to identify those moments of interest signaled by the user in the content being recorded.

A common time or sequencing 38 may provide an indication of a time for a time stamp so that the time or moment of interest can be identified.

In both embodiments, post capture and real time identification of frames of interest, the frame closest to the designated moment of interest serves as the first approximation of the intended or optimal frame. Having selected a moment of interest by either of the techniques, a second set of analytic criteria may be used to improve frame selection. Frames within a window of time before and after the initial selection may be scored against the criteria and a local maximum within the moment window may be selected. In some embodiments, a manual control may be provided to override the virtual frame selection.

A number of different capture scenarios may be contemplated. Capture may be initiated by sensor data. Examples of sensor data based capture may be global positioning system coordinate, acceleration or time data capture. The capture of images may be based on data sensed on the person carrying the camera or by characteristics of movement or other features of an object depicted in an imaged scene or a set of frames.

Thus, when the user crosses the finish line he or she may be at a particular global positioning point that causes a body mounted camera to snap a picture. Similarly, the acceleration of the camera itself may trigger a picture so that a picture of the scene as observed by a ski jumper may be captured. However, the video frames may be analyzed for objects moving with a certain acceleration which may trigger capture. Since many cameras include onboard accelerometers and other sensor data that may be included in the metadata associated with the captured image or frames, this information is easily available. Capture can also be triggered by time which may also be included in the captured frame.

In other embodiments, objects may be detected, objects may be recognized, and spoken commands or speech may be detected or actually understood and recognized as the capture trigger. For example when the user says “capture”, the frame may be captured. When the user's voice is recognized, in the captured audio, that may be the trigger to capture a frame or set of frames. Likewise when a particular statement is made, that may trigger image capture. And still another example, a statement is made that has a certain meaning may trigger image capture. And still other examples when particular objects are recognized within the image, image capture may be initiated.

In some embodiments, training may be associated with image detection, recognition or understanding embodiments. Thus a system may be trained to recognize voice, to understand the user's speech, or to associate given objects with the captured triggering. This may be done during a set up phase using graphical user interfaces in some embodiments.

In other embodiments, there may be intelligence in the selection of the actual captured frame. When the trigger is received, a frame proximate to the trigger point may be selected based on a number of criteria including the quality of the actual captured image frame. For example, overexposed or underexposed frames proximate the trigger point may be skipped to obtain the closest-in-time frame of good image quality.

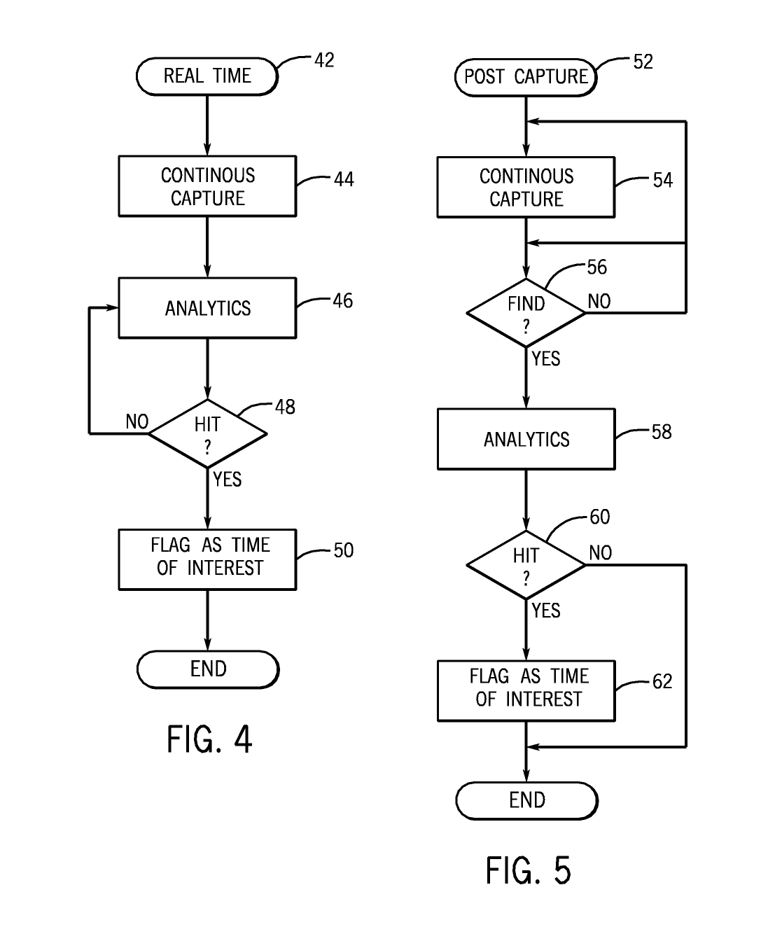

Thus referring to FIG. 4, a sequence 42 may be provided to implement the post-captured virtual shutter embodiment. The sequence 42 may be implemented in software, firmware and/or hardware. In software and firmware embodiments, it may be implemented by computer executed instructions stored in a non-transitory computer readable medium such as a magnetic, optical or semiconductor storage.

The sequence 42 proceeds by directing the imaging device 10 to continuously capture frames as indicated in block 44. Real time capture of moments of interest is facilitated by audio or video analytics unit 46 that analyzes the captured video and audio for queues that indicate that a particular sequence is to be captured. For example, an eye-blinking gesture or a hand gesture may be used to signal a moment of interest. Similarly a particular sound may be made to indicate a moment of interest. Once the analytics identifies the signal, a hit may be indicated as determined in diamond 48. Then the time may be flagged as of interest in block 50. In some embodiments instead of flagging a particular frame, a time may be indicated using a time stamp for example. Then frames proximate to the time of interest may be flagged so that the user does not have to provide the indication with a high degree of timing accuracy.

Referring next to FIG. 5, in a post-capture embodiment, again the sequence 52 may be implemented in software, firmware and/or hardware. In software and firmware embodiments it may be implemented using computer executed instructions stored in a non-transitory computer readable medium such as an optical, magnetic, or semiconductor storage.

The sequence 52 also performs continuous capture of a series of frames as indicated in block 54. A check at diamond 56 determines whether a request to find a moment of interest has been received. If so, analytics may be used as indicated in block 58 to analyze the recorded content to identify a moment of interest having particular features. The content may be audio and/or video content. The features can be any audio or video analytically determinable signal that the user may have deliberately done at the time or may recall having been done at the time that is useful to identify a particular moment of interest. If a hit is detected at diamond 60, a time frame corresponding to the time of the hit may be flagged as a moment of interest as indicated at block 62. Again, instead of flagging a particular frame, a time may be used instead in some embodiments to make the identification of frames less skilled dependent.

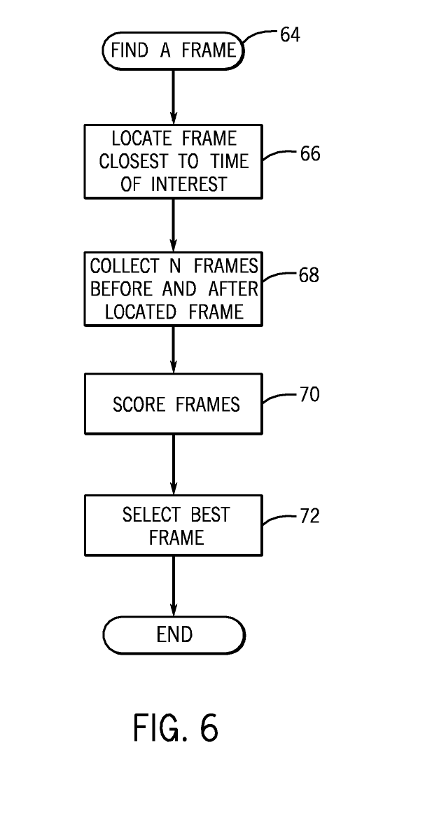

Finally turning to FIG. 6, at sequence 64 may be used to identify those frames that are truly of interest. The sequence 64 may be implemented in software, firmware and/or hardware. In software and firmware embodiments it may be implemented by computer readable instructions stored in an nontransitory computer readable medium such as a semiconductor, optical, or magnetic storage.

The sequence 64 begins by locating that frame which is closest to the recorded time of interest as indicated in block 66. A predetermined number of frames may be collected before and after the located frame as indicated in block 68.

Next as indicated in block 70, the frames may be scored. The frames may be scored based on their similarity as determined by video or audio analytics to the features that were specified as the basis for identifying moments of interest.

Then the best frame may be selected as indicated in block 72 and used as an index into the set of frames. In some cases only the best frame may be used. In other cases a clip may be defined within a set of sequential frames defined by how close the frames score to the ideal.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using a computer for buttonless frame selection from within captured image content.

2. The method of claim 1 including using video or audio analytics for frame selection.

3. The method of claim 1 including deleting a queue in the captured video content, and using the queue for frame selection.

4. The method of claim 1 including capturing frames continuously and selecting frames captured continuously using buttonless frame selection.

5. The method of claim 4 including flagging a frame of interest among said continuously captured frames.

6. The method of claim 4 including locating a frame captured at a time proximate to said time of interest.

7. The method of claim 6 including locating a number of frames proximate to said frame at said time of interest.

8. The method of claim 7 including evaluating said number of frames to select frames of interest.

9. The method of claim 1 including recognizing a spoken command to control image capture.

10. The method of claim 1 including capturing a frame in response to speech recognition.

11. A non-transitory computer readable medium storing instructions to enable a computer to:
use a computer for buttonless frame selection from within captured image content.

12. The medium of claim 11 further storing instructions to use video or audio analytics for frame selection.

13. The medium of claim 11 further storing instructions to delete a queue in the captured video content, and use the queue for frame selection.

14. The medium of claim 11 further storing instructions to capture frames continuously and select frames captured continuously using buttonless frame selection.

15. The medium of claim 11 further storing instructions to flag a frame of interest among said continuously captured frames.

16. The medium of claim 11 further storing instructions to locate a frame captured at a time proximate to said time of interest.

17. The medium of claim 11 further storing instructions to locate a number of frames to said frames at said time of interest.

18. The medium of claim 11 further storing instructions to evaluate said number of frames to select frames of interest.

19. The medium of claim 11 further storing instructions to recognize a spoken command to control image capture.

20. The medium of claim 11 further storing instructions to capture a frame in response to speech recognition.

21. An apparatus comprising:
an imaging device to capture a series of frames; and
a processor to select a frame for storage based on recognition of a sound or image in the frame.

22. The apparatus of claim 21 said processor to use video or audio analytics for frame selection.

23. The apparatus of claim 21 said processor to delete a queue in the captured video content, and use the queue for frame selection.

24. The apparatus of claim 21 said processor to capture frames continuously and select frames captured continuously using buttonless frame selection.

25. The apparatus of claim 21 said processor to flag a frame of interest among said continuously captured frames.

26. The apparatus of claim 21 said processor to locate a frame captured at a time proximate to said time of interest.

27. The apparatus of claim 21 said processor to locate a number of frames to said frames at said time of interest.

28. The apparatus of claim 21 said processor to evaluate said number of frames to select frames of interest.

29. The apparatus of claim 21 said processor to recognize a spoken command to control image capture.

30. The apparatus of claim 21 said processor to capture a frame in response to speech recognition.
